(19) United States
(12) Patent Application Publication
(10) Pub. No.: US 2003/0120849 A1
(43) Pub. Date: Jun. 26, 2003

(54) PDA presentation system

(76) Inventors: Thomas K. Roslak, Eastport, NY (US); Dominick Salvato, North Salem, NY (US); Michael Sasloff, Hastings on Hudson, NY (US); Andrew M. Doorty, Stony Brook, NY (US); Charles S. Bolen, Kings Park, NY (US)

Correspondence Address: Glenn F. Frankenberger, Symbol Technologies, Inc., One Symbol Plaza A-6, Holtsville, NY, 11742-1300, US

(21) Appl. No.: 10/155,602

(22) Filed: May 23, 2002

Related U.S. Application Data
(60) Provisional application No. 60/297,290, filed on Jun. 11, 2001.

(51) Int. Cl. G06F 13/00

(52) U.S. Cl. 710/303

(57) ABSTRACT

An accessory module is provided for connection to the USB docking port of a personal digital assistant (PDA). The accessory unit provides additional functionality to the PDA, and in an exemplary embodiment provides a video driver for retrieving display data from the PDA and generating a video driving signal for a display of the data, for example, for a presentation.

This application claims the benefit of Provisional Application Serial No. 60/297,290, filed Jun. 11, 2001.

### BACKGROUND OF THE INVENTION

This invention relates to accessories for use with programmable digital assistant (PDA) devices. In particular, the invention relates to accessories for displaying images, such as PowerPoint presentations slides, on a display device using a PDA and to accessories for providing additional wireless local area network (WLAN) radio communications and/or bar codes scanning capabilities to a PDA. It is an object of the present invention to provide accessories and methods which expand the capability of a PDA for purposes of making presentations and communicating.

### SUMMARY OF THE INVENTION

In accordance with the invention, there is provided an accessory for use with a PDA device having a docking connector. The accessory includes an accessory connector arranged to mate with docking connector. The accessory further includes an interface controller connected to the accessory connector and arranged to act as a host to the PDA for receiving display data from the PDA. A video controller is provided in the accessory for receiving the display data from the interface controller and for generating video display signals A video output connector is provider on the accessory for receiving the video display signals and providing them as output signals to a display.

The accessory connector and video output connector are preferably arranged on a housing and the housing is arranged to mechanically mount to the PDA. In one arrangement, the housing includes first and second extending sidewalls and the sidewalls are arranged to slidingly receive the PDA there between. The accessory may also include a further connector for attachment of a ether accessory. The further accessory may comprise a memory device.

In accordance with the invention, there is provided an accessory for use with a PDA device having a docking connector. The accessory includes an accessory connector is arranged to mate with the docking connector. An interface controller is connected to the accessory connector and arranged to act as the host to the PDA for sending and receiving data to and from the PDA. An accessory circuit is provided for providing accessory functionality to the PDA.

In one embodiment, the accessory circuit comprises a radio module. Alternatively, the accessory circuit can include a bar code scanner. In one arrangement, the accessory circuit can include a microcontroller for handling the flow of data to other accessory circuits. The accessory may include a further connector for attachment to a further accessory.

In accordance with the invention there is provided a method for presenting information on a display connected to a network. Display information is provided on a server connected to the network. A PDA having a wireless connection to the network is provided. The PDA is operated to communicate display commands to the server via wireless network connection, and display information is communicated to the display via the network.

In one arrangement, the display data is communicated to the display over a wired network. In an alternate arrangement the display data is communicated to the display over a wireless network. In one arrangement, there is provided a further step of identifying a network address of the display to the server. The network address can be provided to the server by providing the PDA with a bar code scanner. The step of identity may include scanning a bar code with the PDA to derive display identification data from the bar code and communicating the display identification data to the server via the wireless connection.

In accordance with another aspect of the invention, audience feedback during a presentation can be obtained using PDA's having WLAN radios. In one arrangement oral presentation sounds are recorded in a first memory loop having a selected duration. Audience entries on a PDA are recorded in a second memory with the current content of the first memory loop.

Inquiries may be presented to the audience as part of a presentation or using the PDA.

In another variation audience feedback entries are recorded with a designation of the last display electronically presented to the audience in a sequence.

For a better understanding of the present invention, together with other and further objects, reference is made to the following description, taken in conjunction with the accompanying drawings, and its scope will be pointed out in the appended claims.

### BRIEF DESCRIPTION OF TIRE DRAWINGS

FIG. 1 is a block diagram showing an accessory in accordance with the invention connected between a PDA and a display monitor.

FIG. 2 is a block diagram showing further details of the PDA and accessory of FIG. 1.

FIG. 3 is a detailed block diagram showing an alternative accessory arrangement in accordance with the present invention.

FIG. 4 is a side view showing a possible physical arrangement for the PDA and accessory of FIG. 1.

FIG. 5 is a top view of the FIG. 4 accessory without the PDA.

FIG. 6 is a left end view of the FIG. 4 accessory without the PDA.

FIG. 7 is a perspective view of the accessory of FIGS. 4, 5 and 6 with an upper cover open.

FIG. 8 is an end view of an alternate embodiment of the accessory of FIGS. 4 through 7.

FIG. 9 is a block diagram showing a PDA and an alternate accessory configuration.

FIG. 10 is a block diagram illustrating the use of a PDA in connection with presentation methods according to the invention.

### DESCRIPTION OF THE INVENTION

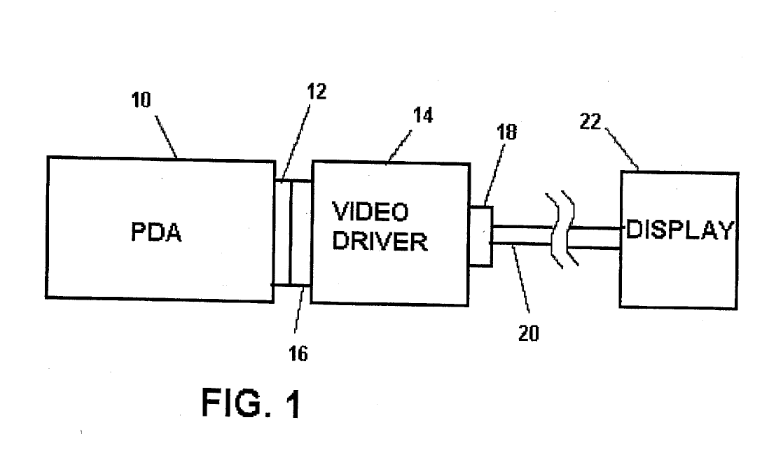

FIG. 1, is a block diagram showing a personal digital assistant (PDA) 10 having a connector 12 for docking to a host computer docking port. An accessory module 14 is provided with a connector 16 which is arranged to mate with connector 12 for purposes of providing accessory functions to PDA 10. In the particular arrangement of FIG. 1, accessory module 14 is a video driver module and will be further explained. Video driver module 14 has a video output connector 18, which is a conventional 15 pin video connector. Connector 18 is connected by video cable 20 to a display monitor 22 of the type conventionally used with personal computers. By the use of an accessory 14 with PDA 10, it is possible to make a presentation on a video monitor, such as a PowerPoint type slide presentation, using data stored in PDA 10. Accordingly, an individual can make a presentation to a small group using a computer type video monitor 22, or to a larger group using a computer type projector using accessory 14, which provides the function of the video display driver of personal computer, which is otherwise not available in PDA 10. Accordingly, rather than carrying a bulky notebook type computer for making a presentation, an individual can carry personal digital assistant 10 and a relatively small accessory unit 14 and use a projector or monitor supplied by those he is visiting and to whom the presentation is made.

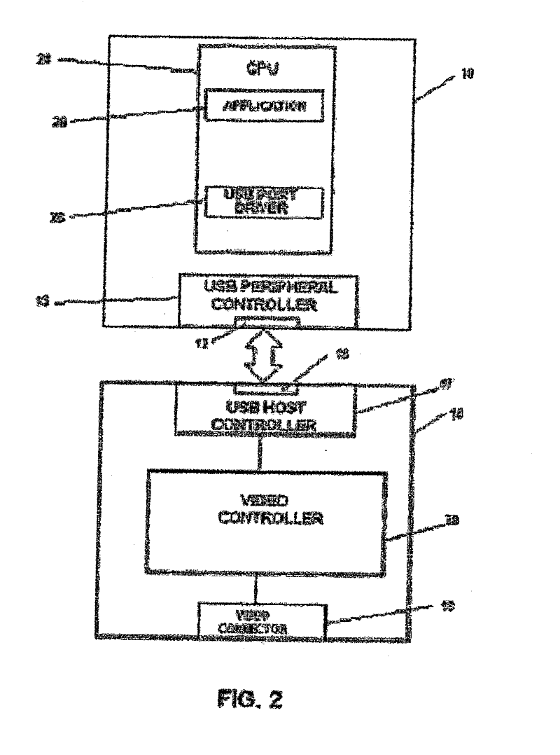

Referring to FIG. 2, there is shown a detailed block diagram of the personal digital assistant 10 and video driver accessory 14. PDA 10 includes a central processing unit 24 which includes an application program 26, which may be a program for providing a PowerPoint type presentation. In addition, CPU 24 includes software for driving the universal serial bus port of the PDA 10 which is normally connected to a host computer when the PDA is docked in a host computer. The USB port driver 28 is usually arranged to act as slave unit when the PDA 10 is docked to a host computer. PDA 10 includes a USB peripherally controller 13 and a connector 12 for docking. Accessory unit 14 includes a USB host controller 17 with a connector 16 for mating to connector 12 of PDA 10. Host controller 17 is arranged to emulate the host controller which is used by a personal computer when a PDA is docked, for purposes of data exchange. In accessory unit 14 the USB host controller is used to initiate and control communications with the USB peripheral controller 13 of PDA 10 for purpose of obtaining data therefrom. In contrast to using the RS232 port of the CPU 24 in PDA 10, use of the USB port conventionally used for docking the PDA to a host computer enables a much higher rate of data transfer between PDA 10 and Accessory 14. Accessory 14 includes a video controller 30, which is designed to generate a video signal using data transferred from PDA 10 via USB host controller 17. The output of video controller 30 is a set of video signals which is provided to video connector 18 for subsequent transfer to a video monitor, such as computer monitor 22 or a computer projector, for projecting a display corresponding to the transferred data.

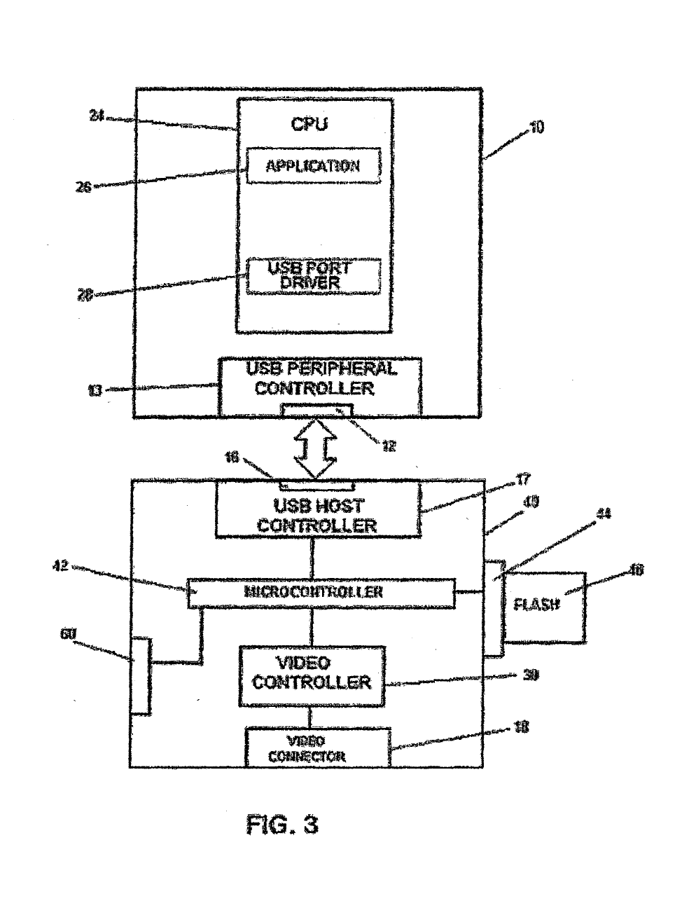

FIG. 3 is a block diagram of an alternate arrangement for an accessory unit 40 according to the present invention. Accessory 40 is similar to accessory unit 14 of FIG. 2 and corresponding portions thereof are given the same reference numbers. Accessory 40 additional has an onboard microcontroller 42, which may be a one chip microcomputer or may include an appropriately programmed digital signal processor chip. Microcontroller 42 is connected to receive display data alternatively from USB host controller 17 or from flash memory 46 which is connected to microcontroller 42 by flash connector 44. Accordingly, it is possible to alternately receive data to be displayed by video controller 30 either from PDA 10 or from flash memory 46. PDA 10, can be used to provide signals to control the operation of microcontroller 42 to select the display data to be provided to video controller 30 from either flash memory 46 or from memory within PDA 10 and to control presentation thereof. Accessory 40 of FIG. 2 can optionally include a further connector (60) which would enable the accessory 40 to be connected to a further accessory, such as wireless local area network (WLAN) radio transmitter/receiver or an optical bar code reader for providing data to PDA 10.

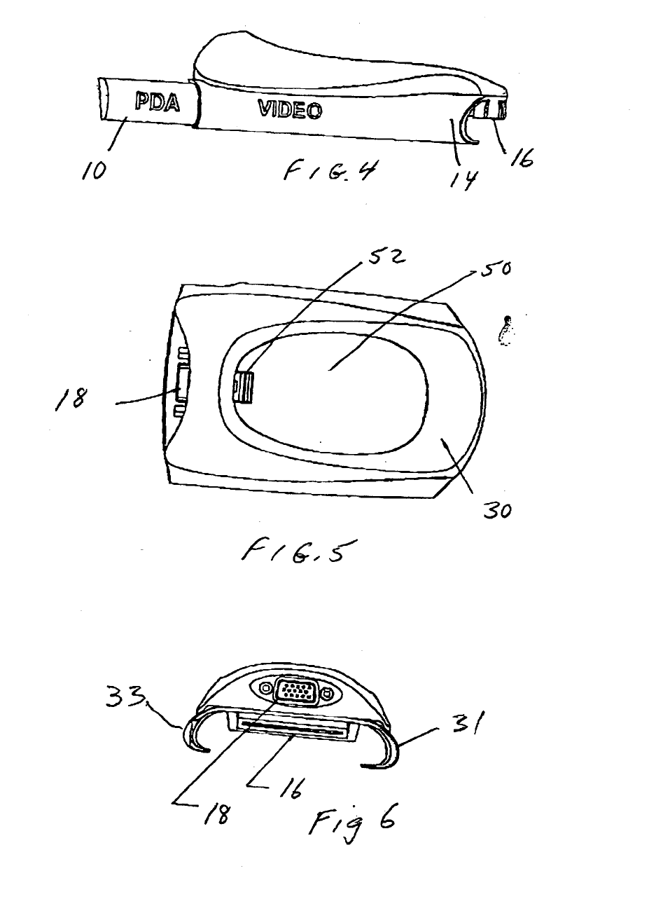

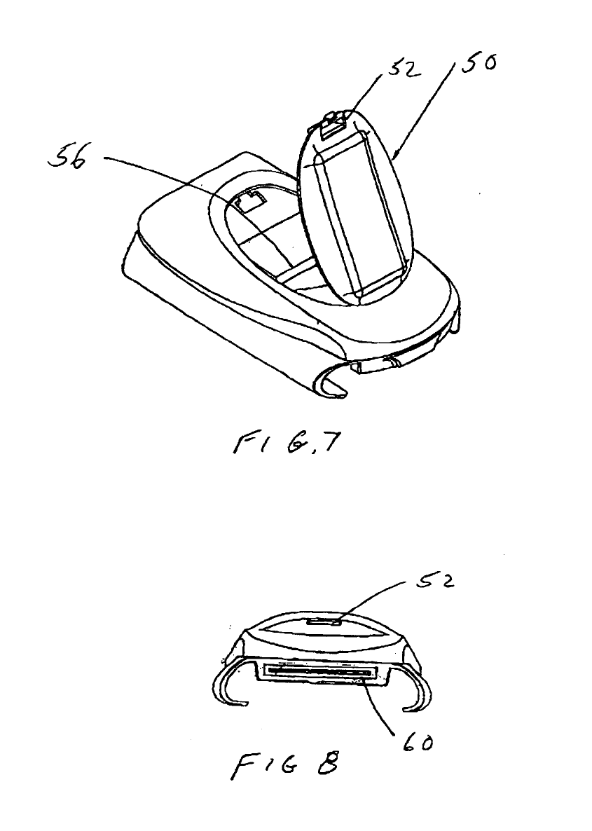

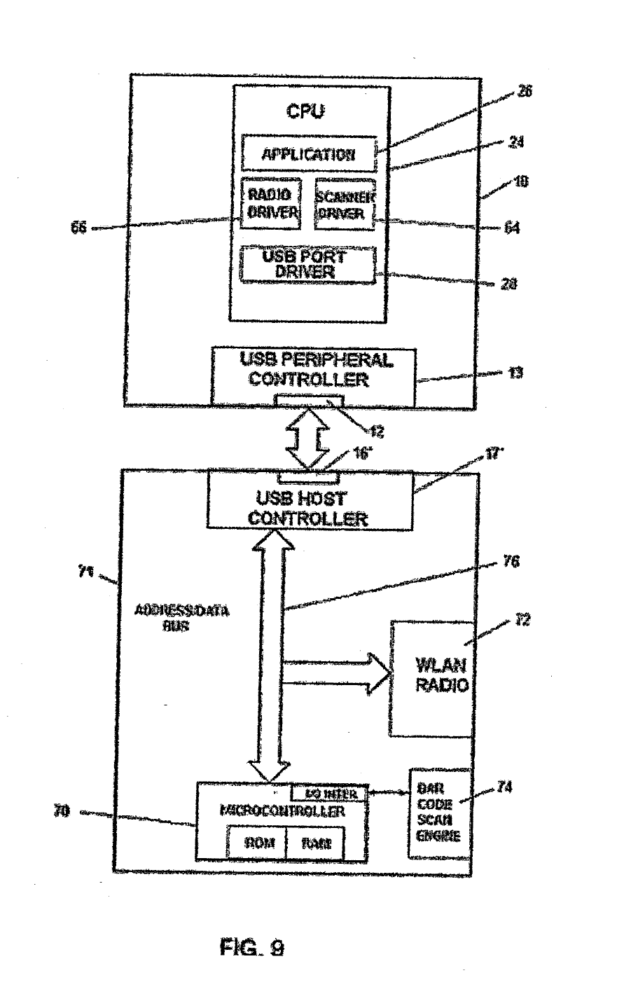

FIGS. 4 through 6 show respectively a side view, a top view and a front view of an advantageous mechanical arrangement for a housing for an accessory to a PDA in accordance with the present invention. The side view of FIG. 4 shows a PDA 10 fitted into the accessory 14. The accessory housing includes extended sides 31 and 33 which are spaced to receive the sides of the PDA as it is inserted into a connector 16 which mates with the docking connector of the PDA. The accessory housing further includes a standard 15 pin video cable connector 18 for connection to a video monitor as discussed above. Referring to FIG. 5, in one arrangement the accessory may include a hinged opening 50 on the top wall thereof which includes a latch 52. As shown in detail in FIG. 7, when latch 15 is opened there is a provided a recess 56 which may receive the flash memory card 46 in the embodiment of FIG. 3. FIG. 8 shows a right side end view of an alternate version of the housing for an accessory 14 wherein a further connector 60 is provided for connection to other accessory units.

FIG. 9 shows a block diagram of an alternate arrangement of an accessory for operation with a PDA 10. The same reference numerals are used in FIG. 9 as in respect to earlier embodiments. CPU 24 of PDA 10 of FIG. 9 includes a software module 66 which is a radio driver and a software module 64 which is a scanner driver. PDA 10 of FIG. 9 includes a USB peripheral controller 13 and connector 12 which interfaces with connector 16′ and USB host controller 17′ of accessory unit 71. The USB host controller 17′ of accessory 71 is connected to an address/data bus 76 which is also connected to microcontroller 70 and WLAN radio 72 of accessory 71. The input/output interface of microcontroller 70 is coupled to a bar code scan engine 74. Accessory 71 of FIG. 9 interfaces with PDA 10 and provides additional functionality which is not present in PDA 10, such as the WLAN radio 72 and a bar code scan engine 74, or both of them. Host controller 17′ acts to control communications through the USB interface between PDA 10 and accessory 71. With accessory 71 attached, PDA 10 can function as a bar code scanner to read bar codes on items and communicate on WLAN radio unit 72 to relay data to a host computer over a wireless network, such as an IEEE type 802.11 wireless local area network, such as the Spectrum 24 network which is available from the assignee of the present invention.

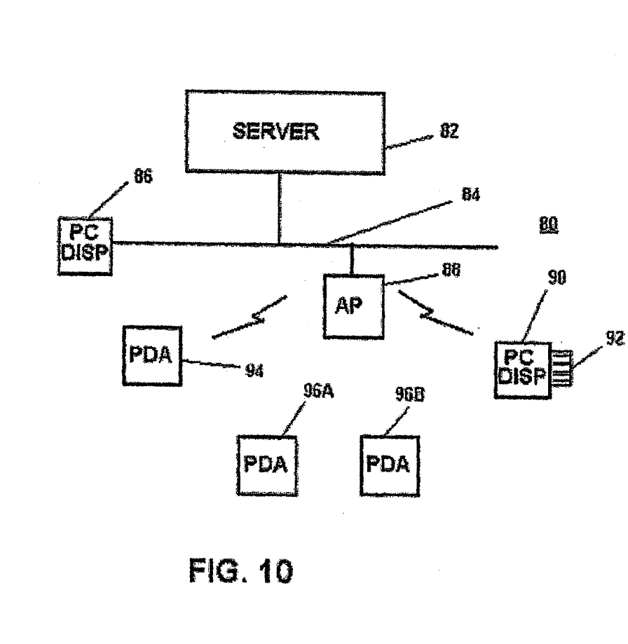

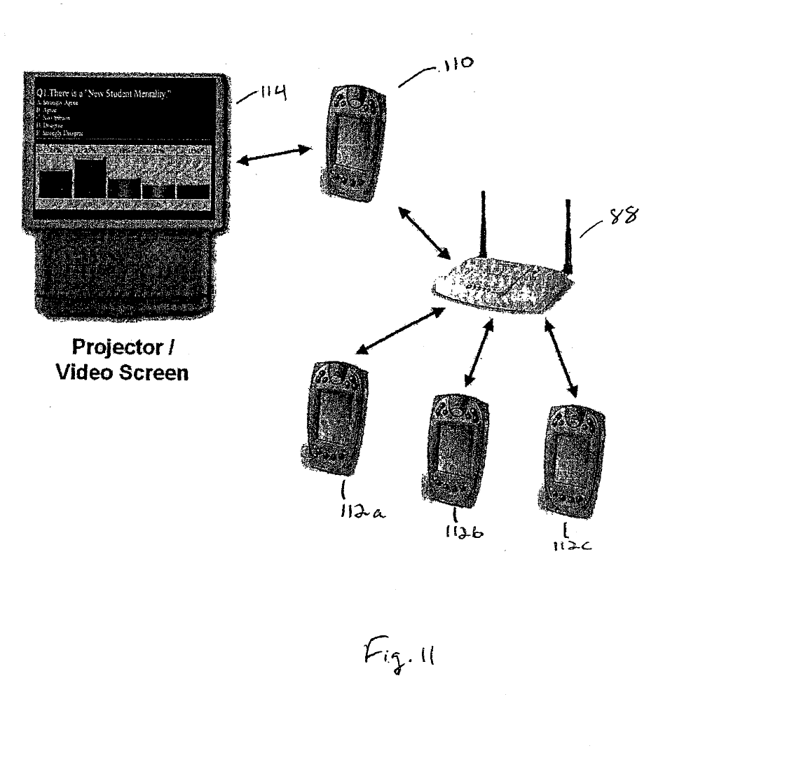

FIG. 10 illustrates a network system 80 wherein a server 82 is interconnected over a wired network 84 with client computer 86 having a display monitor and with an access point 88 of a wireless local area network. Access point 88 is arranged for wireless data communications with a personal digital assistant 94 having a wireless local area network radio and with a wireless capable personal computer 90 having a display monitor. The system 80 of FIG. 10 is arranged to provide the capability of controlling a presentation display on personal computer 86 or personal computer 90 using PDA 94 as a control unit. It should be understood that wired network 84 may be a dedicated proprietary wired network but may also be the internet wherein a server can engage in data communications with personal computer 86 or personal compute 90 in order to provide information thereto.

The arrangement of FIG. 10 may use a PDA 94 having an accessory, such as the accessory 71 illustrated in FIG. 9. In particular, PDA 94 is used to control a flow of data from server 82 to a selected personal computer, 86 or 90, using either wired network 84 or a wireless network connected with the server 82 by access point 88. PDA 94 is in communication with access point 88 and it can provide a command to server 82 to download selected data, such as presentation data, for example slide displays, such as Power Point, or a video file, such as an MPEG file, to a selected computer which is accessed by network 84, such as computer 86 or computer 90. In response to the command from PDA 94, server 82 will download data for purposes of, for example, a display on the selected personal computer. In the case of personal computer 86, the data is provided over wired network 84, which may have greater bandwidth, to handle MPEG video segments, for example. In the case of portable computer 90 data may be provided through access point 88 via a WLAN to personal computer 90. Personal computer 90 and/or personal computer 86 or other items may be provided with a bar code 92 for purposes of identifying the personal computer to which server 82 will download data to the display. For example, if the accessory 71 shown in FIG. 9, is provided on PDA 94, by reading bar code 92 on PC 90, PDA is able to send the identification, and consequently, the network address of PC 90 via access point 88 and network 84 to server 82 so that server 82 has an address to which data can be downloaded.

In the arrangement and method illustrated in FIG. 10, the communications from PDA 94 to server 82 are in the nature of commands, particularly where the display is made on PC 86, the data to be displayed can be downloaded from server 82 over a high capacity network 84. In addition, the PDA is not required to have the capability of storing and handling what might be a large amount of data for a slide or video presentation. It will be recognized that, as an alternative, where the PDA 94 is provided with both the accessory 14 of FIG. 2 and accessory 71 of FIG. 9, or alternatively, where a WLAN radio is built into the PDA, it is possible to request that server 82 download data to be displayed to PDA 94 and the data can be provided to accessory 14 for generation of a video signal to be provided directly to a display monitor 22 in the configuration of FIG. 1.

Another feature of the configuration of FIG. 10 is that members of an audience viewing a presentation can be provided with further PDA devices 96A, 96B, etc. The further PDA devices can communicate with access point 88 over the WLAN and provide audience reaction and feedback as the presentation progresses. In one arrangement server 82 can record feedback data from PDA's 96 associated with the display data currently being presented to coordinate the feedback with the appropriate portion of the presentation. This feedback can be recorded by server 82, or alternatively provided to the presenter via PDA 94 to give the presenter an indication of whether his message is being positively received and/or understood by the audience members.

As an additional feature, the presenter's PDA 94 can be programmed to receive the voice message via microphone and record the voice presentation as digital sound in a continuous memory loop for example, having a length of for example 30 seconds, that overwrites itself. The voice loop segment can be stored along with a feedback reaction, for example if the audience members indicate a lack of comprehension by entries on their PDA's 96. The storage of a voice can be triggered by an indication of a low level of comprehension by the audience. Thereafter the presenter can determine which portions of the presentation need to be expanded or explained in more detail at a future lesson.

While there have been described what are believed to be the preferred embodiments of the invention, those skilled in the art will recognize that other and further changes and modifications will be made thereto without departing from the spirit of the invention and it is intended to claim all such changes and modification as fall within the scope of the invention.

I claim:

1. An accessory for use with a PDA device having a docking connector, comprising: an
accessory connector arranged to mate with said docking connector;
an interface controller connected to said accessory connector and arranged to act as a host to said PDA for receiving display data from said PDA;
a video controller for receiving said display data from said interface controller and for generating video display signals; and
a video output connector for providing said video display signals to a display.

2. An accessory as specified in claim 1 wherein said accessory connector and said video output connector are arranged on a housing, and wherein said housing is arranged to mechanically mount to said PDA.

3. An accessory as specified in claim 2 wherein said housing includes first and second extending sidewalls, and wherein said sidewalls are arranged to slidingly receive said PDA there between.

4. An accessory as specified in claim 1 wherein said accessory includes a further connector for attachment of a further accessory.

5. An accessory as specified in claim 1 wherein said further accessory comprises a memory device.

6. An accessory for use with a PDA device having a docking connector, comprising:
an accessory connector arranged to mate with said docking connector;
an interface controller connected to said accessory connector and arranged to act as a host to said PDA for sending and receiving data to and from said PDA; and
an accessory circuit for providing accessory functionality to said PDA

7. An accessory as specified in claim 6 wherein said accessory circuit comprises a radio module.

8. An accessory as specified in claim 6 wherein said accessory circuit comprises a bar code scanner.

9. An accessory as specified in claim 8 wherein said accessory circuit includes a microcontroller.

10. An accessory as specified in claim 6 wherein said accessory includes a further connector for attachment of a further accessory.

11. A method for presenting information on a display connected to a network, comprising:
providing display information on a server connected to said network;
providing a PDA having a wireless connection to said network;
operating said PDA to communicate display commands to said server via said wireless connection; and
communicating said display information to said display via said network.

12. A method as specified in claim 11 wherein said communicating comprises communicating over a wired network from said server to said display.

13. A method as specified in claim 11 wherein said communicating comprises communicating over a wireless network from said server to display.

14. A method as specified in claim 11 further comprising identifying a network address of said display to said server.

15. A method as specified in claim 14, wherein said providing a PDA comprises providing a PDA with a bar code scanner, and wherein said step of identifying comprises scanning a bar code with said PDA, deriving display identification data from said bar code and communicating said identification data to said server via said wireless connection.

16. A method for obtaining audience feedback during an oral presentation, comprising:
providing at least some audience members with a PDA having a WLAN radio;
recording oral presentation sounds in a continuous first memory loop having a selected duration; and
receiving audience member entries on said PDA and recording said entries in a second memory with the current content of said first memory loop.

17. A method as specified in claim 16 farther including presenting inquiries to said audience members on said PDA's to elicit said audience member entries

18. A method for obtaining audience feedback during a presentation using an electronic presentation display comprising:
providing a least some audience members with a PDA having a WLAN radio; and
receiving audience member entries on said PDA's and recording said entries in a memory with a designation of the current display presented.

19. A method as specified in claim 18 further including sending inquiries to said PDA's for presentation to said audience members in coordination with the presentation of said display presentation.
